(19) United States
(12) Patent Application Publication
(10) Pub. No.: US 2023/0278001 A1
(43) Pub. Date: Sep. 7, 2023

(54) DEVICE FOR RADIAL SEPARATION IN SIMULATED MOVING BED

(71) Applicant: IFP Energies Nouvelles, Rueil-Malmaison (FR)

(72) Inventors: Alexandre VONNER, Rueil-Malmaison Cedex (FR); Damien LEINEKUGEL LE COCQ, Rueil-Malmaison Cedex (FR); Guillaume BLANCKE, Rueil-Malmaison Cedex (FR); Frederic AUGIER, Rueil-Malmaison Cedex (FR); Aude ROYON-LEBEAUD, Rueil-Malmaison Cedex (FR); Manel FOURATI, Rueil-Malmaison Cedex (FR); Amir Hossein AHMADI-MOTLAGH, Rueil-Malmaison Cedex (FR)

(73) Assignee: IFP Energies Nouvelles, Rueil-Malmaison (FR)

(21) Appl. No.: 18/018,068

(22) PCT Filed: Jul. 20, 2021
(86) PCT No.: PCT/EP2021/070297

§ 371 Date: Jan. 26, 2023

(30) Foreign Application Priority Data
Jul. 27, 2020 (FR) FR2007909

(51) Int. Cl. B01J 19/24; B01J 4/00; B01D 15/18

(52) U.S. Cl. CPC B01J 19/2415; B01J 4/004; B01D 15/1842; B01J 2204/002

(57) ABSTRACT

The present invention relates to a device, a column and a method for radial separation or reaction, wherein the adsorption chamber (9) has a charging height (H3) greater than the height of the distribution duct (6) and the height of the collecting duct (8), and the upper wall (2) of the adsorption chamber (9) comprises at least one inlet (16) for washing solvent.

### TECHNICAL FIELD

The present invention relates to a radial device for separating or reacting fluids, for example in a separation method, such as a simulated moving bed separation method, notably for xylenes, or in a reaction method, such as a catalytic reforming method.

### PRIOR ART

The current technologies for separation by simulated moving bed (sometimes abbreviated to SMB in the remainder of the text) use units which have a certain number of common features:
a succession of separation devices (also known as adsorbers) each comprising an adsorption chamber positioned between a distribution duct and a collecting duct, said adsorption chamber comprising an adsorbent bed within which a fluid flows,
injection systems, notably for injecting the feedstock and the desorbent, and withdrawing systems, notably for withdrawing the produced effluents referred to as extract and raffinate,
collection and redistribution systems, referred to as inter-bed zones, for passing from one bed to the next bed.

However, when we examined SMB separation technology in radial adsorbent beds, we found that the solid adsorbent becomes compacted over the course of time in the adsorbent bed, with the effect of creating a flow space devoid of solid adsorbents and of thus reducing the efficiency and the purity of the products separated.

The current technology of radial reaction devices, such as radial reactors for catalytic reforming, employs a fluidtight textile placed in the adsorption chamber and stuck to the surface of the bed by a raised pressure, so as to conform to the surface of the solid. Thus, the creation of a flow space devoid of solid adsorbents in the adsorption chamber is avoided as the solid compacts, something which comes about over the course of time.

By contrast, the use of a fluidtight textile is difficult to apply to the radial use of SMB separation devices because the plugging with the fluidtight textile of part of the adsorption chamber, between the distribution duct and the collecting duct, may generate a chamber in which fluids stagnate (referred to as a “dead” volume) which is detrimental to the performance of the separation method, and also disruption to the fluid distribution and collecting system, this hydrodynamic disruption causing the streams to become imbalanced and also being detrimental to the performance of the method.

### SUMMARY OF THE INVENTION

The present invention, in a first aspect, relates to a device for radial separation (e.g. in a simulated moving bed) or reaction (e.g. catalytic reforming) equipped with a cylindrical vessel, comprising:
a lateral wall,
an upper wall,
a lower wall,
at least one inlet for fluid to be separated,
at least one vertical distribution duct,
at least one fluid outlet,
at least one vertical collecting duct,
an adsorption chamber designed to contain a bed of (solid) adsorbents, the adsorption chamber being positioned between the distribution duct and the collecting duct and extending from the upper wall to the lower wall,
at least one distribution grid positioned between the distribution duct and the adsorption chamber, and
at least one collecting grid positioned between the collecting duct and the adsorption chamber, wherein
the adsorption chamber has a charging height greater than the height of the distribution duct and the height of the collecting duct, and
the upper wall comprises at least one inlet for washing solvent.

Advantageously, the device according to the present invention allows the distribution and collecting surface areas, particularly at the upper end of the adsorption chamber, to be kept constant over the course of time in spite of the phenomena whereby the adsorbent beds become compacted over the course of time. Thus, the device according to the present invention also allows the system to maintain a high level of separation performance.

According to one or more embodiments, the charging height is at least 1% greater than the height of the distribution duct and the height of the collecting duct.

According to one or more embodiments, the charging height is between 1 and 10% greater than the height of the distribution duct and the height of the collecting duct.

According to one or more embodiments, the charging height is between 1.5 and 7% greater than the height of the distribution duct and the height of the collecting duct.

According to one or more embodiments, said at least one washing-solvent inlet is designed to provide a washing-solvent flow rate such that the ratio of the flow rate of the washing solvent to the flow rate of the fluid is comprised between 0.001 and 0.15.

According to one or more embodiments, said at least one washing-solvent inlet comprises a plurality of washing-solvent orifices distributed over the cross section of the additional adsorbent solid and/or a perforated plate and/or a distributor plate.

According to one or more embodiments, the device further comprises a central wall parallel to the lateral wall.

According to one or more embodiments, the distribution duct and the collecting duct are suitable for fluid downflow or fluid upflow.

According to one or more embodiments, the distribution duct is central and the collecting duct is peripheral, or the distribution duct is peripheral and the collecting duct is central.

According to one or more embodiments, the bottom limit of the adsorption chamber corresponds to the bottom limits of the distribution duct and of the collecting duct.

The present invention, in a second aspect, relates to a column comprising at least 1 device according to the first aspect.

The present invention, in a third aspect, relates to a separation or reaction method using a plurality of devices according to the first aspect or a plurality of columns according to the second aspect, in which method:
a fluid is introduced into the distribution duct, the fluid is distributed in the adsorption chamber and collected in the collecting duct, and
a washing solvent is introduced into the adsorption chamber and the washing solvent is collected in the collecting duct with the fluid.

Other features and advantages of the invention according to the aforementioned aspects will become apparent on reading the following description and studying non-limiting exemplary embodiments, with reference to the appended figures described below.

### LIST OF THE FIGURES

FIG. 1 shows a view in axisymmetric section on the vertical axis Z of a reference device for radial separation by SMB.

FIG. 2 shows a view in axisymmetric section on the vertical axis Z of the device according to FIG. 1, in which a fluidtight textile is added to plug the upper part of the adsorption chamber after the solid adsorbents that form the adsorbent bed have become compacted.

FIG. 3 shows a view in axisymmetric section on the vertical axis Z of a device according to one embodiment of the invention, for radial separation by SMB, and in which an additional height of solid adsorbent is added in the upper part of the adsorption chamber.

FIG. 4 shows a view in axisymmetric section on the vertical axis Z of the device according to FIG. 3, in which the additional height of adsorbent solid has filled in for the compaction of the solid adsorbents by flowing under the effect of gravity.

### DESCRIPTION OF THE EMBODIMENTS

The present invention may be defined as a radial device (e.g. reactor) for the separation (e.g. by SMB) of compounds (e.g. xylenes) or the reaction (e.g. catalytic reforming) of compounds (e.g. naphtha). Said radial device may notably be positioned (e.g. in series) within one or more columns, notably for the SMB separation of xylenes (e.g. paraxylene), the column or columns being divided into N radial devices and comprising N adsorbent beds, the N adsorbent beds being separated by 2N inter-bed zones (i.e. N distribution zones and N collecting zones). As a preference, the number N is comprised between 4 and 24, preferably comprised between 8 and 15, and highly preferably between 8 and 12.

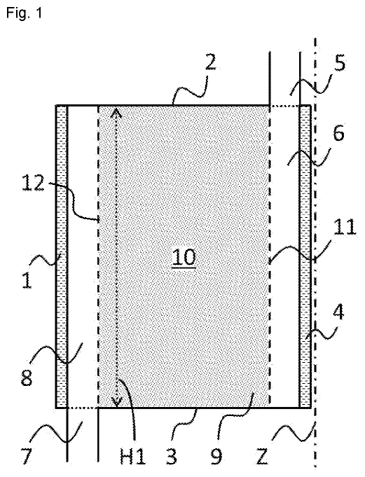

With reference to FIG. 1, a reference device for radial separation by SMB comprises a cylindrical vessel equipped with a cylindrical lateral wall 1, an upper wall 2, a lower wall 3 and, optionally, a central wall 4 parallel to the lateral wall 2, i.e. positioned vertically to enhance the robustness of the vessel. The vessel further comprises:
at least one inlet 5 for fluid to be separated, hereinafter referred to as upper inlet, adjacent to the upper wall 2;
at least one vertical distribution duct 6, e.g. one extending from the upper inlet 5 to the lower wall 3;
at least one fluid outlet 7, hereinafter referred to as lower outlet, adjacent to the lower wall 3; and
at least one vertical collecting duct 8, e.g. one extending upwards from the lower outlet 7 over a height substantially (to within ±10%, preferably ±5%) equal to the height of the distribution duct 6.

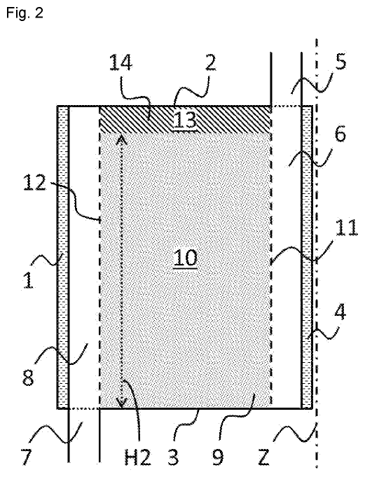

The vessel further comprises an adsorption chamber 9 (e.g. of cylindrical tubular shape) positioned between the distribution duct 6 and the collecting duct 8, extending from the upper wall 2 to the lower wall 3 and designed to contain an adsorbent bed 10 over a duct height H1 corresponding to the height of the distribution duct 6 and of the collecting duct 8. The device further comprises at least one distribution grid 11, or any other means known to those skilled in the art for distributing liquid, such as a perforated plate, positioned between the distribution duct 6 and the adsorption chamber 9 and at least one collecting grid 12 positioned between the collecting duct 8 and the adsorption chamber 9, said distribution and collecting grids 11 and 12 allowing the passage of fluid between the distribution and collecting ducts 6 and 8 and the adsorption chamber 9. In this example of FIG. 1, the flow of fluid in the device is a downflow, i.e. the fluid arrives in the device via the upper inlet 5 and leaves the device via the lower outlet 7. By contrast, the flow of fluid may be an upflow from a lower inlet to an upper outlet. In addition, in this example of FIG. 1, the radial flow of fluid in the adsorption chamber 9 is outwards, i.e. from the central upper inlet 5 towards the lateral lower outlet 7. By contrast, the radial flow of fluid in the adsorption chamber 9 may be inwards, i.e. from a peripheral upper/lower inlet towards a central lower/upper outlet. It will also be appreciated that the radial device according to the present application can be rotated through 90°, namely may have distribution and collecting ducts 7 and 8 which are horizontal. As shown in FIG. 1, in normal operation, the adsorbent bed 10 completely (e.g. at least 99%) fills the adsorption chamber 9. With reference to FIG. 2, when the solid adsorbents (particles) that form the adsorbent bed 10 become compacted from the duct height H1 to a height H2 less than the duct height H1 during operation of the device, one solution known to those skilled in the art is to add a fluidtight textile 13 to the adsorption chamber 9 to plug the upper part 14 of the adsorption chamber 9 and thus prevent fluid from flowing through a zone in which there is no adsorbent. By contrast, the presence of the fluidtight textile 13 on the upper part 14 of the adsorption chamber 9 causes fluid retention which is detrimental to the performance of the separation method. In this example, a stagnant volume is notably observed at the top of the collecting duct 8, accompanied by a change in the hydrodynamics in the distribution duct 6 with a reduction in the cross section open to the passage of the liquid towards the adsorbent bed 10, which is detrimental to performance.

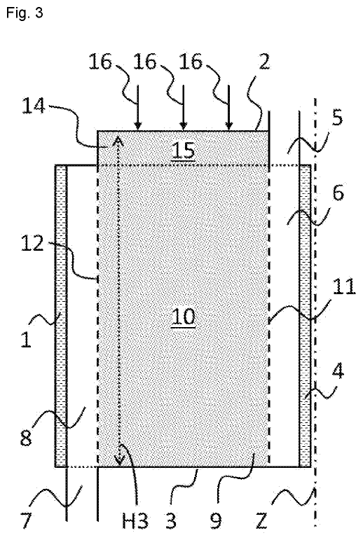

With reference to FIG. 3, the device for radial separation by SMB according to the present invention comprises the same elements referenced from 1 to 12 in the reference device. Furthermore, in the device according to the present invention, the adsorption chamber 9 has a charging height H3 from the upper wall 2 to the lower wall 3 that is greater than the height of the distribution duct 6 and of the collecting duct 8. In this way, the upper part 14 of the adsorption chamber 9 is adapted so that it can contain an additional height of adsorbent solid 15 so that the adsorbent bed 10 has a charging height H3 at least 1%, preferably at least 3%, highly preferably at least 5% greater than the height of the distribution duct 6 and of the collecting duct 8. According to one or more embodiments, the adsorbent bed has a charging height that is between 1 and 10%, and preferably between 1.5 and 7%, greater than the height of the distribution duct and of the collecting duct.

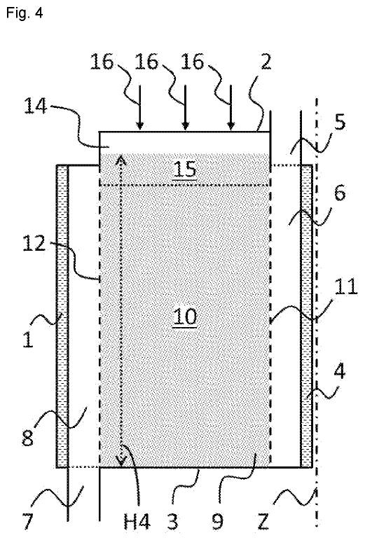

With reference to FIG. 4, when the adsorption chamber 9 is charged with an adsorbent bed 10 with a charge height H3 greater than the duct height H1 of the distribution duct 6 and of the collecting duct 8, and if the solid in the adsorbent bed 10 becomes compacted during operation, some of the additional height of adsorbent solid 15 advantageously accompanies said compaction by flowing under the effect of gravity, thus making it possible to maintain a compaction height H4 at least greater than or equal to the duct height H1. According to one or more embodiments, the charge height H3 is designed so that the compaction height H4 is at least 1.0 times, preferably 1.02 times, highly preferably 1.04 times, greater than the duct height H1.

According to one or more embodiments, the bottom limit of the adsorption chamber 9 (e.g. corresponding to the position of the lower wall 3) also corresponds to the bottom limits of the distribution duct 6 and of the collecting duct 8. According to one or more embodiments, the top limit of the adsorption chamber 9 (e.g. corresponding to the position of the upper wall 2) is at least 1.01 times, preferably 1.05 times, highly preferably 1.10 times higher than the top limit of the distribution duct 6 and of the collecting duct 8.

With reference to FIGS. 3 and 4, the device according to the present invention further comprises at least one washing-solvent inlet 16 positioned on the upper wall 2 of the vessel. The washing-solvent inlet 16 notably allows a washing solvent to be introduced into the adsorption chamber 9 so as to wash the additional height of adsorbent solid 15 and limit a flow of fluid in the additional height of adsorbent solid 15. According to one or more embodiments, the washing solvent is a compound used as a desorbent in the SMB separation method. According to one or more embodiments, the washing solvent is selected from toluene and 1,4-diethylbenzene. According to one or more embodiments, the ratio of the flow rate of the washing solvent to the flow rate of the fluid is comprised between 0.001 and 0.15, preferably comprised between 0.005 and 0.10, and highly preferably comprised between 0.01 and 0.08.

Advantageously, the additional height of adsorbent solid 15 is swept by a downflow of washing solvent so as to limit the hydrodynamic disturbances that could be generated by the circulation of the fluid in the volume (known as the slowing zone) corresponding to the additional height of adsorbent solid 15 and which might cause hydrodynamic dispersion.

### EXAMPLES

A reference column A for SMB separation is made up of 15 reference devices as depicted in FIG. 1, comprising 15 adsorbent beds arranged in series, and separated by 30 inter-bed zones. Each bed has a volume of 29.4 m³ and a bed porosity of 32.8%. The performance levels achieved by the column A are a paraxylene (PX) purity of 99.7%, a paraxylene yield of 97.7% and a productivity of 93.4 kg/h/m³.

A reference column B for SMB separation is made up of 15 reference devices as depicted in FIG. 2, comprising 15 adsorbent beds arranged in series, and separated by 30 inter-bed zones. Each bed has a volume of 29.4 m³ and a bed porosity of 32.8%. In column B, the solid adsorbent experiences, in the 15 beds, a compaction of 8% by volume during operation, which is filled in by means of a fluidtight textile arranged in the adsorption chamber and stuck to the surface of the bed by a raised pressure. By modifying the settings of the unit in order to achieve the same levels of paraxylene purity (99.7%) and yield (97.7%) as reference column A, the productivity of the system is reduced to 72.3 kg/h/m³, representing a loss of 22.5%.

A column C according to the invention for SMB separation is made up of 15 devices according to the invention as depicted in FIG. 3, comprising 15 adsorbent beds arranged in series, and separated by 30 inter-bed zones. Each bed has a volume of 29.4 m³ and a bed porosity of 32.8%. In column C, the solid adsorbent experiences, in the 15 beds, a compaction of 8% by volume during operation, which is filled in by means of an additional height of 10.0% of adsorbent solid 15 arranged in the upper part 14 of the adsorption chamber 9. An additional volume of 2.9 m³ of adsorbent solid is thus obtained in each adsorbent bed, each of these additional volumes being swept by a downflow of washing solvent corresponding to 4% of the “pump-around” overall flow rate circulating through the unit. By modifying the settings of the unit in order to achieve the same levels of paraxylene purity (99.7%) and yield (97.7%) as reference column A, the productivity of the system is reduced to 83.4 kg/h/m³, representing a loss of just 10%.

1. Device for radial separation or reaction equipped with a cylindrical vessel comprising:
a lateral wall (1),
an upper wall (2),
a lower wall (3),
at least one inlet (5) for fluid to be separated,
at least one vertical distribution duct (6),
at least one fluid outlet (7),
at least one vertical collecting duct (8),
an adsorption chamber (9) designed to contain a solid adsorbent bed (10), the adsorption chamber (9) being positioned between the distribution duct (6) and the collecting duct (8) and extending from the upper wall (2) to the lower wall (3),
at least one distribution grid (11) positioned between the distribution duct (6) and the adsorption chamber (9), and
at least one collecting grid (12) positioned between the collecting duct (8) and the adsorption chamber (9),
wherein
the adsorption chamber (9) has a charging height (H3) greater than the height of the distribution duct (6) and the height of the collecting duct (8), and
the upper wall (2) comprises at least one inlet (16) for washing solvent.

2. Device according to claim 1, wherein the charging height (H3) is at least 1% greater than the height of the distribution duct (6) and the height of the collecting duct (8).

3. Device according to claim 2, wherein the charging height (H3) is between 1 and 10% greater than the height of the distribution duct (6) and the height of the collecting duct (8).

4. Device according to claim 3, wherein the charging height (H3) is between 1.5 and 7% greater than the height of the distribution duct (6) and the height of the collecting duct (8).

5. Device according to claim 1, wherein said at least one washing-solvent inlet (16) comprises a plurality of washing-solvent orifices (16) distributed over the adsorbent solid and/or a perforated plate and/or a distributor plate.

6. Device according to claim 1, further comprising a central wall (4) parallel to the lateral wall (1).

7. Device according to claim 1, wherein the distribution duct (6) and the collecting duct (8) are suitable for fluid downflow or fluid upflow.

8. Device according to claim 1, wherein the distribution duct (6) is central and the collecting duct (8) is peripheral, or the distribution duct (6) is peripheral and the collecting duct (8) is central.

9. Device according to claim 1, wherein the bottom limit of the adsorption chamber (9) corresponds to the bottom limits of the distribution duct (6) and of the collecting duct (8).

10. Column comprising at least one device according to claim 1.

11. Separation or reaction method using a plurality of devices according to claim 1 or a plurality of columns each comprising at least one of said devices, in which method:
a fluid is introduced into the distribution duct (6), the fluid is distributed in the adsorption chamber (9) and collected in the collecting duct (8), and
a washing solvent is introduced into the adsorption chamber (9) and the washing solvent is collected in the collecting duct (8) with the fluid.

12. Process according to claim 11, wherein a washing-solvent flow rate is provided to the washing solvent inlet (16) such that the ratio of the flow rate of the washing solvent to the flow rate of the fluid is comprised between 0.001 and 0.15.
